(19) United States
(12) Patent Application Publication
(10) Pub. No.: US 2022/0407167 A1
(43) Pub. Date: Dec. 22, 2022

(54) LIQUID-COOLED MOTOR VEHICLE TRACTION BATTERY MODULE

(71) Applicant: Dr. Ing. h.c. F. Porsche Aktiengesellschaft, Stuttgart (DE)

(72) Inventors: Philipp Kellner, Renningen (DE); Christopher Volkmer, Niefern-Oschelbronn (DE)

(73) Assignee: Dr. Ing. h.c. F. Porsche Aktiengesellschaft, Stuttgart (DE)

(21) Appl. No.: 17/841,752

(22) Filed: Jun. 16, 2022

(30) Foreign Application Priority Data
Jun. 17, 2021 (DE) 10 2021 115 657.2

(51) Int. Cl. H01M 50/249; H01M 50/204; H01M 50/289; H01M 10/613; H01M 10/625; H01M 10/6555; H01M 10/6557

(52) U.S. Cl. CPC H01M 50/249; H01M 50/204; H01M 50/289; H01M 10/613; H01M 10/625; H01M 10/6555; H01M 10/6557; H01M 2220/20

(57) ABSTRACT

A liquid-cooled motor vehicle traction battery module with a rigid and fluid-tight module housing in which a plurality of plate-like identical battery cells are accommodated. A plurality of identical deformable compression elements are provided between the battery cells and the battery cells are cooled by module-internal liquid cooling. Rigid cooling plates, which have cooling ducts for cooling liquid, are arranged between two mutually adjacent battery cells. Either a cooling plate or a compression element, against which the battery cells respectively directly bear, is in each case alternately arranged between two mutually adjacent battery cells.

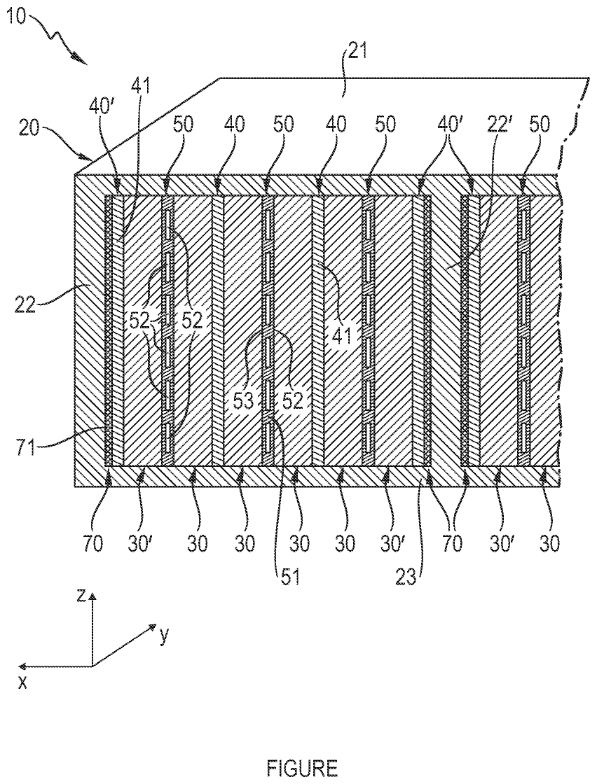

### CROSS-REFERENCE TO RELATED APPLICATION

This application claims priority to German Patent Application No. 10 2021 115 657.2, filed Jun. 17, 2021, the content of such application being incorporated by reference herein in its entirety.

### FIELD OF THE INVENTION

The invention relates to a liquid-cooled motor vehicle traction battery module.

### BACKGROUND OF THE INVENTION

A plurality of battery cells are stacked in a module housing of the traction battery module to form a cell stack, wherein the battery cells are generally connected to one another electrically in series. In order firstly to allow high levels of energy output during driving operation and to allow high levels of energy consumption during charging operation, motor vehicle traction battery modules according to the prior art are liquid-cooled inside the module, for which purpose cooling guide structures can be provided in the module housing. Over the service life of the traction battery module, the plate-like battery cells swell, and therefore compressible compression elements which are elastically or plastically deformable and compensate for the swelling of the battery cells by correspondingly decreasing in size are provided between the battery cells.

Various examples of the design and the grouping of battery cells and compression elements are known from WO 2021/070 018 A1, which is incorporated by reference herein. However, the cooling structures and the compression elements take up a considerable amount of belly space within the module housing. The cooling is hampered by the fact that, in particular, plate-like or cushion-like compression elements can have only a very low degree of thermal conductivity.

### SUMMARY OF THE INVENTION

Described herein is a compact motor vehicle traction battery module which can be cooled with a high cooling capacity.

The traction battery module according to aspects of the invention has a rigid and fluid-tight module housing in which a plurality of plate-like and identical battery cells are accommodated, the battery cells being stacked vertically or horizontally with their base planes parallel to one another to form a cell stack. A plurality of battery cells are generally connected to one another or interconnected electrically in series. The battery cells are cooled by module-internal liquid cooling.

Either a rigid cooling plate, which has cooling ducts for a cooling liquid, is arranged or an elastically or plastically deformed compression element is provided in alternating sequence between two mutually adjacent battery cells. Therefore, the two large side faces of each battery cell adjoin in each case directly firstly a compression element and secondly a cooling plate. Two battery cells always directly adjoin one cooling plate. A cooling plate therefore always directly cools two battery cells, and at least one compression element directly adjoins two battery cells. Since both a cooling plate and a compression element are functionally associated with in each case two battery cells, a compact design is implemented in this way in the direction of the normal to the plate base planes of the battery cells. Nevertheless, a high cooling capacity is rendered possible and ensured by way of each battery cell directly adjoining a cooling plate which has cooling ducts for a circulating cooling liquid.

The cooling concept is particularly preferably what is known as immersion cooling in which the battery cells are directly cooled by the cooling liquid at points. However, only narrow sides of the battery cells are directly cooled here, with the result that a considerable cooling capacity for the traction battery module can be implemented only above the cooling plates cooled by the cooling liquid via cooling ducts.

The module housing is generally rectangular, rigid and designed in a stable manner in such a way that it can serve as a supporting element for the motor vehicle frame, and in particular can serve for transverse reinforcement. The module housing preferably has a plurality of wall panels which are parallel to one another and to the battery cells, wherein a compression element bears indirectly or directly against each wall panel and a battery cell bears directly against the compression element. A wall panel of the module housing can be an outer housing wall, but can also be a housing-internal separating wall. The wall panels are arranged parallel to the base plane of the plate-like battery cells. Therefore, a cooling plate directly adjoining a wall panel is not provided. Two battery cells are always directly cooled by each cooling plate.

The compression elements can be designed in various ways in principle. For example, the compression elements can be of plastically or elastically deformable design. The compression elements can be designed as individual spring elements. The compression elements are preferably of plate-like and/or cushion-like and elastic design. Compression elements of this kind absorb the compression forces over a large surface area, and therefore the battery cells cannot be damaged as they expand (due to aging).

The two surfaces of the cooling plates, which surfaces make contact with the two adjacent battery cells, are preferably of entirely planar design, with the result that the battery cells cannot be damaged even under relatively high normal forces, as can occur due to age-related expansion of the battery cells.

The cooling fluid flowing in the module housing is preferably a dielectric liquid which is electrically non-conductive. The cooling liquid flows through the cooling ducts of the cooling plates, but also directly flows around the battery cells at points, for example on two, three or four narrow sides of the battery cells. The cooling plates particularly preferably directly adjoin only the two adjoining battery cells, but not a wall of the module housing.

All of the wall panels of the pump housing which are parallel to one another and to the battery cells are preferably formed in one piece with one another and are part of a one-piece metal extrusion profile. The compression elements are preferably each adhesively bonded to at least one of the two adjacent battery cells. Furthermore, a cooling plate can also be adhesively bonded to the other side of the battery cell. These adhesive bonds are made before the traction battery module is assembled, with the result that a bonded-together assembly unit consisting of a compression element, a battery cell and a cooling plate is inserted into the module housing in each case. As a result, the production of the traction battery module is simplified, in particular in the case of a module housing which is formed substantially from a one-piece extrusion profile.

A separate plate-like structural component composed of glass fiber-reinforced composite material is preferably provided or arranged between a wall panel of the module housing and the neighboring compression element. As a result, the crash safety in particular is improved since even a possibly sharp broken edge of the module housing cannot enter the closest battery cell.

### BRIEF DESCRIPTION OF THE DRAWINGS

An exemplary embodiment of the invention will be explained in more detail below with reference to the drawing.

The sole FIGURE shows a diagrammatic and perspective view of a vertical cross section through a motor vehicle traction battery module.

### DETAILED DESCRIPTION OF THE INVENTION

The sole figure shows a perspective view of a vertical cross section through a motor vehicle traction battery module 10 with a rigid and fluid-tight metal module housing 20. The rated voltage of the traction battery module 10 is, for example, 400 V or 800 V, and therefore is what is known as a high-voltage traction battery module. In the present case, “fluid-tight” is to be understood to mean that cooling liquid connections are provided but otherwise the module housing 20 is fluid-tight. The traction battery module 10 is rectangular and elongate in the vehicle transverse direction Y. In the present case, the sectional plane shown lies in a vertical transverse plane XZ of the traction battery module 10, that is to say in a vertical longitudinal plane of the motor vehicle in question.

A top wall 21 situated at the top in a horizontal plane, a lower bottom wall 23 situated in a horizontal plane, a wall panel 22 designed as a side wall and a wall panel 22′ forming a central separating wall of the module housing 20 are illustrated. The right-hand side wall panel is not illustrated. All of the wall panels 22, 22′, the bottom wall 23 and the top wall 21 are formed in one piece with one another and are parts of a metal extrusion profile which is closed by corresponding covers at both of its end sides. The separating wall wall panel 22′ divides the interior of the module housing 20 into two halves which are mirror-inverted with respect to the separating wall wall panel 22′. All of the wall panels 22, 22′ lie in a vertical transverse plane YZ.

Each of the two module housing halves is filled between the wall panels 22, 22′ delimiting them in each case, in each case in accordance with a specific stacking pattern with a plurality of battery cells 30, 30′, a plurality of deformable compression elements 40, 40′, a plurality of cooling plates 50 and two plate-like structural components 70.

The mutually identical battery cells 30, 30′ are in the form of what are known as pouch cells and each have a cell voltage of 30-100 V.

The cooling plates 50 are all of identical design to one another. Each cooling plate 50 is is formed by a cooling plate body 51 in which cooling ducts 52 running linearly in the vehicle transverse direction Y are provided for the cooling liquid flowing through the traction battery module 10. The two large surfaces 53 of each cooling plate 50 are of smooth and planar design, and do not have any sharp edged projections. The cooling liquid is an electrically non-conductive dielectric liquid, for example a suitable oil.

The plate-like and elastically deformable compression elements 40, 40′ are also all of identical design to one another in each case and are formed by a suitable elastic and full-surface-area plastic body 41.

The structural component 70 adjoins each vertical wall panel 22, 22′ in each case, is likewise of plate-like design and is formed by a plate-like body 71 composed of a glass fiber-reinforced composite material.

The structural components 70, the battery cells 30, 30′, the compression elements 40, 40′ and the cooling plates 50 are all parallel to one another in a vertical transverse plane YZ and each have approximately the same base area. The abovementioned elements are arranged in a specific sequence and order in relation to one another: either a cooling plate 50 or a compression element 40, 40′ is respectively alternately arranged between two mutually adjacent battery cells 30, 30′, wherein the battery cells 30, 30′ are each arranged so as to bear directly against the cooling plate 50 in question or directly against the compression element 40, 40′ in question. The plate-like structural component 70 is respectively arranged between a compression element 40′ indirectly adjoining a wall panel 22, 22′ and the wall panel 22, 22′ in question.

For easier assembly, all of the battery cells 30, 30′ are each adhesively bonded to an adjoining compression element 40, 40′ before assembly. It goes without saying that larger units including a cooling plate 50 can also already be combined with other elements by means of appropriate adhesive bonding to form an assembly unit before assembly.

What is claimed is:

1. A motor vehicle traction battery module comprising:
a rigid and fluid-tight module housing,
a plurality of identical battery cells positioned within the housing, wherein the battery cells are configured to be cooled by module-internal liquid cooling,
a plurality of identical deformable compression elements disposed between battery cells, and
rigid cooling plates, which have cooling ducts for cooling liquid, arranged between two mutually adjacent battery cells.

2. The motor vehicle traction battery module as claimed in claim 1, wherein the module housing has a plurality of wall panels which are parallel to one another and to the battery cells, wherein the compression elements bear against the respective wall panels and one of the battery cells bears directly against one of the compression elements.

3. The motor vehicle traction battery module as claimed in claim 1, wherein the compression elements are in the form of plates.

4. The motor vehicle traction battery module as claimed in claim 1, wherein two planar surfaces of the cooling plates make contact with the respectively adjacent battery cells.

5. The motor vehicle traction battery module as claimed in claim 1, wherein the compression elements are each adhesively bonded to at least one of the two adjacent battery cells.

6. The motor vehicle traction battery module as claimed in claim 1, wherein the cooling fluid flowing in the cooling plate cooling ducts is a dielectric liquid which directly cools the battery cells.

7. The motor vehicle traction battery module as claimed in claim 1, wherein wall panels of the module housing, which are parallel to one another, are formed in one piece with one another and are part of an extrusion profile.

8. The motor vehicle traction battery module as claimed in claim 1, wherein a separate structural component composed of glass fiber-reinforced composite material is arranged between a wall panel and a neighboring compression element.

9. A motor vehicle comprising the motor vehicle traction battery module of claim 1.
